(19) United States
(12) Patent Application Publication
(10) Pub. No.: US 2026/0246705 A1
(43) Pub. Date: Aug. 20, 2026

(54) ENABLING PERFORMANCE ANALYTICS OF A TETHERED CONNECTION IN A WIRELESS COMMUNICATION NETWORK

(71) Applicant: LENOVO (SINGAPORE) PTE. LTD., Singapore (SG)

(72) Inventors: Emmanouil Pateromichelakis, Viersen (DE); Razvan-Andrei Stoica, Essen (DE); Dimitrios Karampatsis, Ruislip (GB)

(73) Assignee: Lenovo (Singapore) Pte. Limited, Singapore (SG)

(21) Appl. No.: 19/160,581

(22) PCT Filed: Apr. 19, 2023
(86) PCT No.: PCT/EP2023/060183

§ 371 Date: Aug. 28, 2025

(30) Foreign Application Priority Data
Mar. 3, 2023 (GR) 20230100179

(51) Int. Cl. H04L 41/14; H04W 24/08

(52) U.S. Cl. CPC H04L 41/14; H04W 24/08

(57) ABSTRACT

There is provided a method performed by a first network node for enabling performance analytics of a tethered connection, wherein an application session comprises an end-to-end communication session, and wherein the end-to-end communication session includes the tethered connection. The method comprises: receiving a requirement for performance analytics for the application session; identifying at least one device to serve as data collection entity for collecting data required for the performance analytics; and sending a data collection requirement to the identified data collection entity, the data collection requirement including a request for performance data related to the at least one tethered connection within the application session. The method further comprises: receiving, from the data collection entity, performance data measured in accordance with the data collection requirement; deriving performance analytics based on the performance data and the data collection requirement; and sending the derived performance analytics.

### FIELD

The subject matter disclosed herein relates generally to the field of enabling performance analytics of a tethered connection in a wireless communication network. This document defines a first network node, a method in a first network node, a second network node, a method in a second network node, a third network node, and a method in a third network node.

### INTRODUCTION

In many interactive and immersive applications with challenging requirements on latency, rate and reliability, the application experience is served over a tethered connection whereby an endpoint Personal IoT Network Element (PINE) device is connected to a gateway device which in turn is connected to a 3GPP access network (e.g., 4G, 5G or alike) for Internet connectivity. Examples of such application experience delivery include, for instance, AR/VR experiences where the PINE is a head-mounted device (HMD) in the form of AR/VR glasses and the gateway is a mobile phone, or alternatively, 3GPP user equipment (UE). The E2E connectivity between a client and an application server relies therefore on at least three heterogeneous network segments, i.e., the tethered link, the 3GPP connectivity, and the data network (DN) link. The tethered and DN links are out of scope of 3GPP. The tethering connection between the PINE and the gateway relies usually on Wi-Fi, Bluetooth, or unlicensed spectrum radio access technologies. Such a connection affects the E2E QoS and in effect both the tethered link and the DN link contribute in such a way as to reduce the effectiveness of QoS rules and policies employed within the 3GPP network.

### SUMMARY

As such, it would be helpful for 3GPP networks to monitor and ingest link metrics regarding the performance of out-of-scope network segments (e.g., tether link, DN link) across a heterogeneous E2E network path. A 3GPP network may also perform analytics of such link metrics and derive statistical characterizations of the expected performance. Further such a 3GPP network may adapt the 3GPP QoS rules and policies and compensate for out-of-scope network segments degrading effects (e.g., additional latency etc.) and seamlessly satisfy E2E applications requirements for an enhanced user experience.

Disclosed herein are procedures for enabling performance analytics of a tethered connection in a wireless communication network. Said procedures may be implemented by a first network node, a method in a first network node, a second network node, a method in a second network node, a third network node, and a method in a third network node.

Accordingly, there is provided a first network node for enabling performance analytics of a tethered connection, wherein an application session comprises an end-to-end communication session, and wherein the end-to-end communication session includes the tethered connection. The first network node comprises a processor and a memory coupled with the processor, the processor configured to cause the first network node to: receive a requirement for performance analytics for the application session; identify at least one device to serve as data collection entity for collecting data required for the performance analytics; and send a data collection requirement to the identified data collection entity, the data collection requirement including a request for performance data related to the at least one tethered connection within the application session. The processor is further configured to cause the first network node to: receive, from the data collection entity, performance data measured in accordance with the data collection requirement; derive performance analytics based on the performance data and the data collection requirement; and send the derived performance analytics.

There is further provided a method performed by a first network node for enabling performance analytics of a tethered connection, wherein an application session comprises an end-to-end communication session, and wherein the end-to-end communication session includes the tethered connection. The method comprises: receiving a requirement for performance analytics for the application session; identifying at least one device to serve as data collection entity for collecting data required for the performance analytics; and sending a data collection requirement to the identified data collection entity, the data collection requirement including a request for performance data related to the at least one tethered connection within the application session. The method further comprises: receiving, from the data collection entity, performance data measured in accordance with the data collection requirement; deriving performance analytics based on the performance data and the data collection requirement; and sending the derived performance analytics.

There is further provided a second network node for enabling performance analytics of a tethered connection wherein an application session comprises an end-to-end communication session, and wherein the end-to-end communication session includes the tethered connection. The second network node comprises a processor; and a memory coupled with the processor. The processor is configured to cause the second network node to: receive a data collection requirement from a first network node; determine at least one data source based on the data collection requirement; collect performance data from the at least one data source, the collecting based on the data collection requirement; send the collected performance data to the first network node.

There is further provided a method performed by a second network node for enabling performance analytics of a tethered connection wherein an application session comprises an end-to-end communication session, and wherein the end-to-end communication session includes the tethered connection. The method comprises receiving a data collection requirement from a first network node; determining at least one data source based on the data collection requirement; collecting performance data from the at least one data source, the collecting based on the data collection requirement; and sending the collected performance data to the first network node.

There is further still provided a third network node for enabling performance analytics of a tethered connection within an application session, wherein the application session includes communication via at least one tethered connection. The third network node comprises a processor and a memory coupled with the processor. The processor is configured to cause the third network node to: send a requirement for performance analytics for the application session to a first network node, the requirement for performance analytics including a request for performance data related to the at least one tethered connection within the application session; and receive performance analytics from the first network node.

There is further still provided a method performed by a third network node for enabling performance analytics of a tethered connection within an application session, wherein the application session includes communication via at least one tethered connection. The method comprises sending a requirement for performance analytics for the application session to a first network node, the requirement for performance analytics including a request for performance data related to the at least one tethered connection within the application session; and receiving performance analytics from the first network node.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for enabling performance analytics of a tethered connection in a wireless communication network will now be described, by way of example only, with reference to the accompanying drawings, in which:

FIG. 1 depicts a wireless communication system for enabling performance analytics of a tethered connection in a wireless communication network;

FIG. 2 depicts a user equipment apparatus that may be used for implementing the methods described herein;

FIG. 3 depicts further details of the network node that may be used for implementing the methods described herein;

FIG. 4 which illustrates an overview of a core network XRM architecture handling data packets;

FIG. 5 depicts an implementation of a first tethering approach as tethered standalone glasses;

FIG. 6 illustrates an implementation of AR glasses whereby an XR tethered link exposes an XR runtime to 5G Device as an XR runtime API;

FIG. 7 illustrates an implementation of AR glasses whereby exposure of the XR runtime via the tethering link as media buffer source and sink is supported by a virtualized edge network XR runtime instance;

FIG. 8 illustrates an E2E path and subsequent path delays;

FIG. 9 illustrates an example wireless communication system;

FIG. 10 illustrates a generic DCAF architecture depicted in simplified format;

FIG. 11 depicts an application data analytics enablement architecture in the non-roaming case;

FIG. 12 illustrates a generic functional model for ADAE when re-using the 3GPP network data analytics model;

FIG. 13 illustrates an architecture where the analytics is needed for ADAE-C interface and the VAL client resides at a different UE which is not networked;

FIG. 14 illustrates a Tethered VAL connectivity performance analytics procedure;

FIG. 15 illustrates a method performed by a first network node for enabling performance analytics of a tethered connection, wherein an application session comprises an end-to-end communication session;

FIG. 16 illustrates a method performed by a second network node for enabling performance analytics of a tethered connection wherein an application session comprises an end-to-end communication session; and

FIG. 17 illustrates a method performed by a third network node for enabling performance analytics of a tethered connection within an application session.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

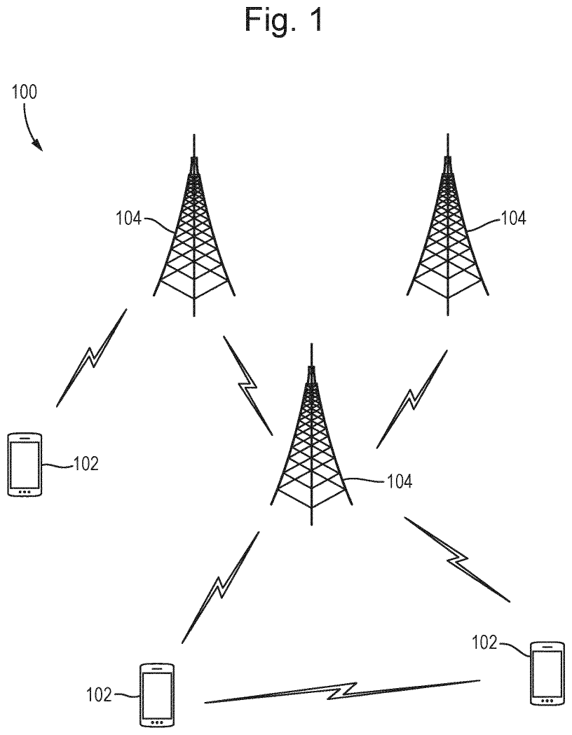

FIG. 1 depicts an embodiment of a wireless communication system 100 for enabling performance analytics of a tethered connection in a wireless communication network. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100. The wireless communication system may comprise a wireless communication network and at least one wireless communication device. The wireless communication device is typically a 3GPP User Equipment (UE). The wireless communication network may comprise at least one network node. The network node may be a network unit.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfox, LoraWAN, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

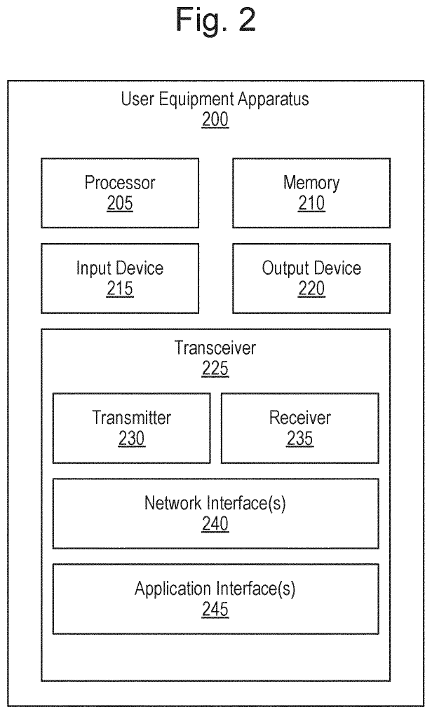

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described herein. In particular, the user equipment apparatus 200 may comprise a remote unit 102, a UE 435, 904, a 5G device 530, 630, 730, or a VAL UE 1110, 1310, as described herein. The user equipment apparatus 200 may comprise a second network node as described herein. The user equipment apparatus 200 may include an application data analytics enablement client (ADAEC) 1114, 1314, 1414 as described herein. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communication network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

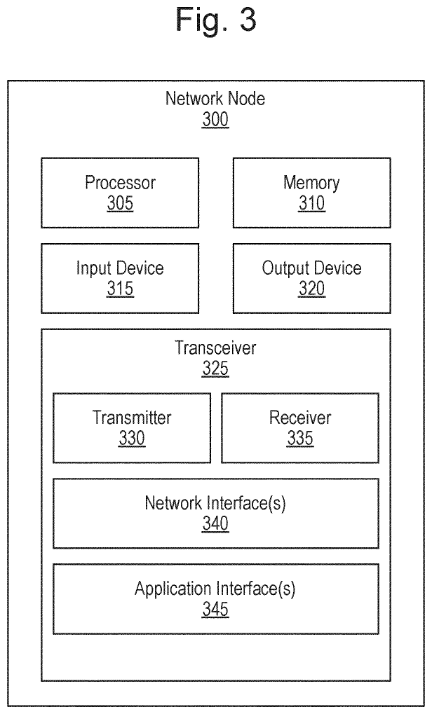

FIG. 3 depicts further details of the network node 300 that may be used for implementing the methods described herein. The network node 300 may be one implementation of an entity in the wireless communication network, e.g. in one or more of the wireless communication networks described herein. The network node 300 may comprise a network unit 104, a RAN 430, a 5G core 1120. The network node 300 may comprise a first network node as described herein. The network node 300 may include an application data analytics enablement server (ADAES) 1164, 1264, 1364, 1464 as described herein. The network node 300 may comprise a third network node as described herein. The network node 300 may include an Application layer-Analytics and Data Repository Function (A-ADRF) 1224 as described herein. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

In many interactive and immersive applications with challenging requirements on latency, rate and reliability, the application experience is served over a tethered connection whereby an endpoint Personal IoT Network Element (PINE) device is connected to a gateway device which in turn is connected to a 3GPP access network (e.g., 4G, 5G or alike) for Internet connectivity. Examples of such application experience delivery include, for instance, AR/VR experiences where the PINE is a head-mounted device (HMD) in the form of AR/VR glasses and the gateway is a mobile phone, or alternatively, 3GPP user equipment (UE). The E2E connectivity between a client and an application server relies therefore on at least three heterogeneous network segments, i.e., the tethered link, the 3GPP connectivity, and the data network (DN) link. The tethered and DN links are out of scope of 3GPP. The tethering connection between the PINE and the gateway relies usually on Wi-Fi, Bluetooth, or unlicensed spectrum radio access technologies. Such a connection affects the E2E QoS and in effect both the tethered link and the DN link contribute in such a way as to reduce the effectiveness of QoS rules and policies employed within the 3GPP network.

As such, it is of high importance for 3GPP networks to monitor and ingest link metrics regarding the performance of out-of-scope network segments (e.g., tether link, DN link) across a heterogeneous E2E network path. A 3GPP network may also perform analytics of such link metrics and derive statistical characterizations of the expected performance. Further such a 3GPP network may adapt the 3GPP QoS rules and policies and compensate for out-of-scope network segments degrading effects (e.g., additional latency etc.) and seamlessly satisfy E2E applications requirements for an enhanced user experience.

There is a need for a solution that facilitates efficient monitoring at the 5G system (including the enablement layer) of the delay components for the end to end application service, assuming that the end UE device is decoupled from the application running (which can be deployed at a tethered UE), and how to guarantee that the service KPI is met, considering different technologies and connective links used along the e2e service (which is not under the control of the 5G system). Each connective link generates a component of the total E2E delay.

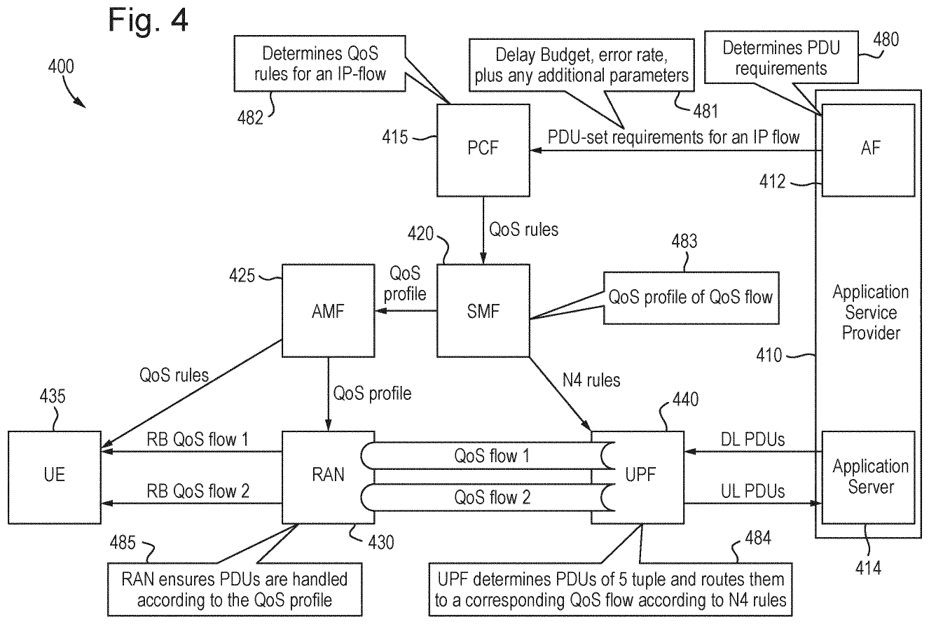

The core network handles packets, which may be Protocol Data Units (PDUs), and which may be grouped into PDU-sets, as shown in FIG. 4, which illustrates an overview of a core network (CN) XRM architecture handling data packets. FIG. 4 shows a system 400 comprising an Extended Reality Media Application Function (XRM AF) 410, a Policy and Control Function (PCF) 415, a Session Management Function (SMF) 420, an Access and Mobility Function (AMF) 425, a Radio Access Network (RAN 430, a User Equipment (UE) 435, a User Plane Function (UPF) 440, and an Application Service Provider 410. The Application Service Provider 410 comprises an Application Function (AF) 412 and an Application Server 414. The UE 435 may comprise a remote unit 102 or a user equipment apparatus 200 as described herein. The RAN 430 may comprise a base unit 104, a network node 300 as described herein. The operation of system 400 will now be described in the example of downlink traffic, a similar process may operate for uplink traffic.

At 480, the AF 412 determines PDU requirements.

At 481, the Application Function 412 provides QoS requirements for packets to the PCF 415 and information to identify the application (i.e. 5-tuple or application id). The QoS requirements may be expressed in terms of delay budget, Packet Delay Budget (PDF), or alternatively, PDU Set Delay Budget (PSDB), error rate, Packet Error Rate (PER), or alternatively, PDU Set Error Rate (PSER).

At 482, the PCF 415 determines QoS rules for the application and specific QoS requirements for the PDU. The QoS rules may use a 5G QoS identifier (5QI) for application traffic. The PCF 415 makes such a determination by determining a 5QI for the application PDU traffic. The PCF 415 sends the QoS rules to the SMF 420 as a 5-tuple PDU QoS Requirement. The PCF 415 may include in the communication to the SMF 420 Policy and Charging Control (PCC) rules per importance of a PDU set. The PCC rules may be derived according to information received from the AF 412 or based on an operator configuration.

At 483, the SMF 420 establishes a QoS flow according to the QoS rules by the PCF 415 and configures the UPF to route packets of the application to a QoS flow. The SMF 420 also provides the QoS profile containing PDU set QoS requirements to the RAN 430 via the AMF 425. The AMF 425 may provide the QoS profile containing PDU set QoS requirements to the RAN 430 in an N2 Session Management (SM) container. Further, the AMF 425 may provide the QoS rules to the UE 435 in an N1 SM container.

At 484, the UPF 440 determines and routes the PDUs of the application (i.e., a 5 tuple) to a corresponding QoS flow, according to the N4 rules received from the SMF 420.

At 485, the RAN 430 receives QFIs, QoS profile of QoS flows from the SMF 420 via the AMF 425 during PDU session establishment/modification, identifies packets belonging to a PDU session of an application over a QoS flow and handles the packets over RBs according to the QoS requirements provided by the SMF 420. The RAN 430 inspects GTP-U headers and ensures PDUs are handled according to the determined QoS profile according to SM container. This may include transmitting some packets in a radio bearer carrying QoS flow 1. This may also include sending other packets in a different radio bearer carrying QoS flow 2.

The general steps described above regarding the QoS flow handling, RB to QoS flow to application flow mapping and PDU session handling are applicable for both UL and DL directions. That is, while the above example relates to downlink (DL) traffic. reciprocal processing is applicable to uplink (UL) traffic wherein the role of UPF 440 packet inspection is taken by the UE 435. The low-level signaling mechanism associated with the UL UE-to-RAN information passing are up to the specification and implementations of RAN signaling procedures.

Herein, extended Reality (XR) is used as an umbrella term for different types of realities, of which Virtual Reality, Augmented Reality, and Mixed Reality are examples.

Virtual Reality (VR) is a rendered version of a delivered visual and audio scene. The rendering is in this case designed to mimic the visual and audio sensory stimuli of the real world as naturally as possible to an observer or user as they move within the limits defined by the application. Virtual reality usually, but not necessarily, requires a user to wear a head mounted display (HMD), to completely replace the user's field of view with a simulated visual component, and to wear headphones, to provide the user with the accompanying audio. Some form of head and motion tracking of the user in VR is usually also necessary to allow the simulated visual and audio components to be updated to ensure that, from the user's perspective, items and sound sources remain consistent with the user's movements. In some implementations additional means to interact with the virtual reality simulation may be provided but are not strictly necessary.

Augmented Reality (AR) is when a user is provided with additional information or artificially generated items, or content overlaid upon their current environment. Such additional information or content will usually be visual and/or audible and their observation of their current environment may be direct, with no intermediate sensing, processing, and rendering, or indirect, where their perception of their environment is relayed via sensors and may be enhanced or processed.

Mixed Reality (MR) is an advanced form of AR where some virtual elements are inserted into the physical scene with the intent to provide the illusion that these elements are part of the real scene.

XR refers to all real-and-virtual combined environments and human-machine interactions generated by computer technology and wearables. It includes representative forms such as AR, MR and VR and the areas interpolated among them. The levels of virtuality range from partially sensory inputs to fully immersive VR. In some circles, a key aspect of XR is considered to be the extension of human experiences especially relating to the senses of existence (represented by VR) and the acquisition of cognition (represented by AR).

In 3GPP Release 17, 3GPP SA4 Working Group analyzed the Media transport Protocol and XR traffic model in the Technical Report TR 26.926 (v1.1.0) titled “Traffic Models and Quality Evaluation Methods for Media and XR Services in 5G Systems”, and decided the QoS requirements in terms of delay budget, data rate and error rate necessary for a satisfactory experience at the application level. These led to 4 additional 5G QoS Identifiers (5QIs) for the 5G System (5GS) XR QoS flows. These 5QIs are defined in 3GPP TS 23.501 (v17.5.0), Table 5.7.4-1, presented there as delay-critical GBR 5QIs valued 87-90. The latter are applicable to XR video streams and control metadata necessary to provide the immersive and interactive XR experiences.

The XR video traffic is mainly composed of multiple DL/UL video streams of high resolution (e.g., at least 1080p dual-eye buffer usually), frames-per-second (e.g., 60+ fps) and high bandwidth (e.g., usually at least 20-30 Mbps) which needs to be transmitted across a network with minimal delay (typically upper bounded by 15-20 ms) to maintain a reduced end-to-end application round-trip interaction delay. The latter requirements are of critical importance given the XR application dependency on cloud/edge processing (e.g., content downloading, viewport generation and configuration, viewport update, viewport rendering, media encoding/transcoding etc.).

Tethered and Heterogeneous Links may be used for Media Applications. In Release 17, 3GPP studied the support of 5G and beyond XR glasses based on a common client architecture, relying on three major components: an XR runtime, a Scene Manager, and a Media Access Function (MAF). Out of the three of general relevance for communications aspects is the MAF.

3GPP Technical Report TR 26.998 (v18.0.0—December 2022) describes Support of 5G Glass-type AR/MR devices, and defines the Media Access Function (MAF) as supporting the AR UE to access and stream media. For this purpose, a MAF includes:
Codecs: used to compress and decompress the media. In several cases, not only a single instance of a codec per media type is needed, but multiple ones.
Content Delivery Protocols: Container format and protocol to deliver media content between the UE and the network according to the requirements of an application. This includes timing, synchronization, reliability, protocol-level reporting (e.g., RTP reporting) and other features.
5G connectivity: a modem and 5G System functionalities that allow the UE to connect to a 5G network and get access to the features and service offered by the 5G System.
Media Session Handler: A generic function on the device to setup 5G System capabilities and support 5GS integration. This may setup edge functionalities, provide QoS support, support reporting functionalities, etc.
Content protection and decryption: This function handles protection of content from being played on unauthorized devices.

Some example implementations of MAF are:
5GMSd client that includes a Media Session Handler and a Media Player as defined in TS 26.501 and TS 26.512.
5GMSu client that includes a Media Session Handler and a Media Streamer as defined in TS 26.501 and TS 26.512.
A real-time communication client that includes either uplink or downlink, or both to support more latency critical communication services, such as for XR applications.

In Release 18, 3GPP is studying further the tethering aspects for XR glass type devices whereby two different tethering approaches are established as:
Tethered standalone glasses: In this case, the glasses run an XR application that uses the capabilities of the glasses to create a service. The glasses are tethered to a 5G device or alike mobile access technology (e.g., a mobile phone) and potentially use the capabilities of the phone (e.g., Media Session Handler) to support the application.
Tethered display glasses: In this case, the glasses are tethered to a 5G device or alike mobile access technology (e.g., a mobile phone) that includes the application and the XR functions, i.e., at least the MAF and/or a lightweight scene manager instance. The 5G device runs the application that uses the capabilities of the 5G device to run an XR experience. The glasses are connected to the 5G device and embed at least a lightweight XR runtime which is exposed to the 5G device either via an XR runtime-specific API over an XR tethered link or via a wireless link exposing media buffers.

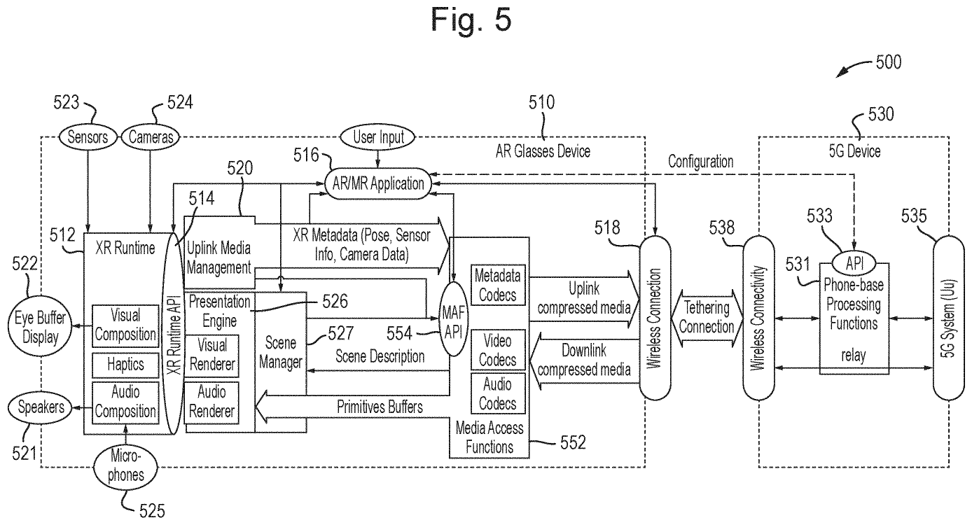

An implementation depicting the first tethering approach as tethered standalone glasses is depicted in FIG. 5. An AR glasses device 510 is tethered to a 5G Device 530. The AR glasses device 510 comprises an XR runtime 512, an XR runtime API 514, an AR/MR application 516, a wireless connection module 518, and a Media Access Function 552. A pair of speakers 521, an eye display buffer 522, sensors 523 and at least one camera 524, provide input to the XR runtime 512, which comprises visual composition, haptics and audio composition. The XR runtime API 514 provides an interface between the XR runtime 512 and each of an uplink media management module 520, and a presentation engine 526. The presentation engine 526 comprises a visual renderer and an audio renderer and interfaces with a scene manager 527. The media access function 552 comprises metadata codecs, video codecs and audio codecs and a MAF API 554. The AR/MR application 516 interfaces with each of the XR runtime API 514, the scene manager 527, and the MAF API 554.

A tethering connection is provided between the AR glasses device 510 and the 5G device 530 by respective wireless connectivity modules 518, 538. The MAF 552 passes compressed media to and from the tethered connection via the wireless connectivity module 518. 5G device 530 likely comprises a smartphone and includes a 5G system module 535. Phone based processing functions are performed by a processor 531. The phone-based processing functions comprise an API 533 which is able to pass configuration information to the AR/MR application 516 via the tethering connection.

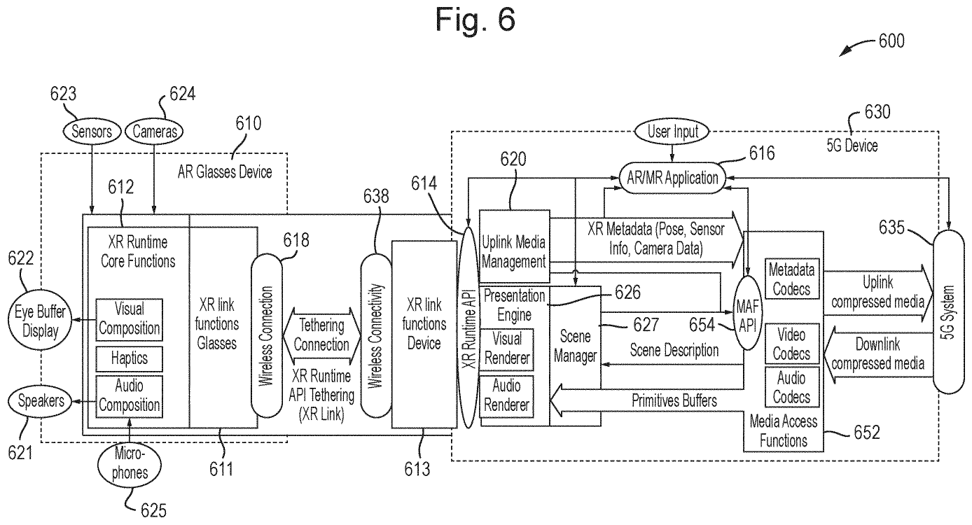

FIG. 6 illustrates an implementation of AR glasses whereby an XR tethered link exposes an XR runtime to 5G Device as an XR runtime API. An AR glasses device 610 is tethered to a 5G Device 630. The AR glasses device 610 comprises an XR runtime core functions 612. A pair of speakers 621, an eye display buffer 622, sensors 623 and at least one camera 624, provide input to the XR runtime core functions 612, which comprises visual composition, haptics and audio composition. An XR link function glasses 611 operates as an interface between the XR runtime core functions 612 and a wireless connection module 618 of the AR glasses device 610.

A tethering connection is provided between the AR glasses device 610 and the 5G device 630 by respective wireless connectivity modules 618, 638. The 5G device 630 comprises an XR link functions device 613 that provides an interface between the wireless connectivity module 638 and the XR runtime API 614. The 5G device 630 further comprises an AR/MR application 616, and a Media Access Function 652. The XR runtime API 614 provides an interface between the XR link functions device 613 and each of an uplink media management module 620, and a presentation engine 626. The presentation engine 626 comprises a visual renderer and an audio renderer and interfaces with a scene manager 627. The media access function 652 comprises metadata codecs, video codecs and audio codecs and a MAF API 654. The AR/MR application 616 interfaces with each of the XR runtime API 614, the scene manager 627, and the MAF API 654. 5G device 630 likely comprises a smartphone and includes a 5G system module 635. The MAF 652 passes compressed media to and from 5G system module 635.

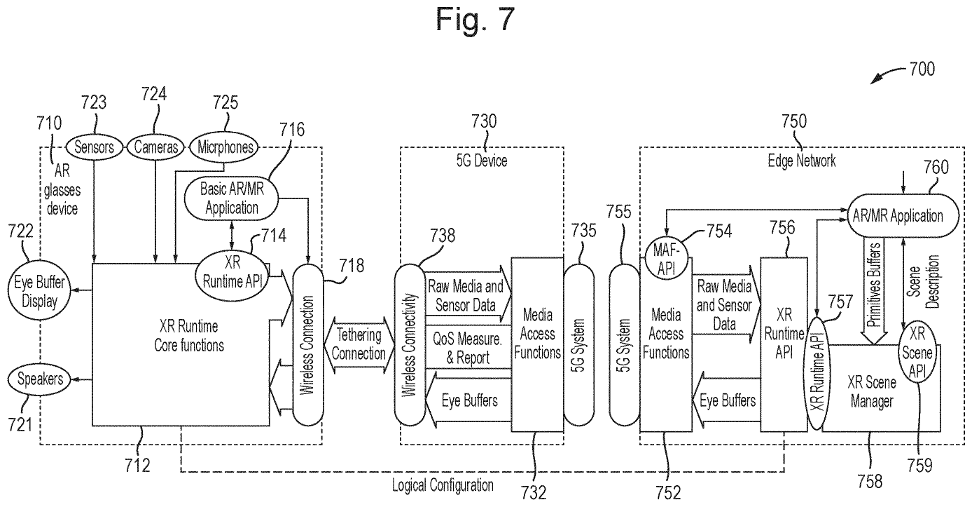

FIG. 7 illustrates an implementation of AR glasses whereby exposure of the XR runtime via the tethering link as media buffer source and sink is supported by a virtualized edge network XR runtime instance. An AR glasses device 710 is tethered to a 5G Device 730; the 5G device 730 is connected to an edge network 750 via a 5G connection. The AR glasses device 710 comprises an XR runtime core functions 712. A pair of speakers 721, an eye display buffer 722, sensors 723 and at least one camera 724, provide input to the XR runtime core functions 712. An XR runtime API 714 provides an interface to a basic AR/MR application 716.

A tethering connection is provided between the AR glasses device 710 and the 5G device 730 by respective wireless connectivity modules 718, 738. The XR runtime core functions 712 of the AR glasses device 510 exchanges data with the 5G device 730 via the tethering connection. 5G device 730 likely comprises a smartphone and includes a 5G system module 735. The 5G device 730 comprises a Media Access Function 732. The MAF 752 passes compressed media to and from 5G system module 735.

The edge network 750 comprises a media access functions 754, an XR runtime 756, an XR scene manager 758, and an AR/MR application 760. The AR/MR application 760 interfaces with the media access functions 752 via a MAF API 754, and with the XR scene manager 758 via a XR scene API 759. An XR runtime API 757 provides an interface between the XR runtime 756 and the XR scene manager 758.

All three tethering architectures of FIGS. 5, 6 and 7 can be supported by edge split-rendering to reduce the complexity, processing requirements, power consumption, and heat dissipation on the XR glasses. To this end, some key issues identified in the Release 18 3GPP tethering study relate to the monitoring and reporting of tethering link and DN link latencies, and respectively, to the management of E2E QoS delay budget.

The latency monitoring and reporting solution presented herein is thus of relevance because in an E2E connection including a tethering link (e.g., Wi-Fi link, or a Bluetooth link), a 5G network and the Internet, the Wi-Fi segment and the Internet segment typically cannot guarantee latency. A low E2E latency is required by the XR applications to provide a good quality of experience (QoE) to the end user. Such a QoE may lead to the experience feeling more immersive to the user and also make the experience feel more interactive. To achieve the requisite low E2E latency of XR applications, one approach is to make the latency in the 5G network very conservative such that the end-to-end latency is below a target value. This, however, comes at a cost, because only a finite bandwidth is available in the wireless communication system and provisioning an unnecessarily low latency in the 5G network requires excessive radio resource allocation. Such excessive radio resource allocation might support a more robust modulation-and-coding scheme (MCS), but would require many other traffic flows to be deprived of bandwidth resources.

Accordingly, the solution presented here is to dynamically adjust the delay in the 5G network in accordance with the total delay incurred elsewhere on the E2E path. This requires a measure of the non 5G delay in the total E2E connection between the tethered headset and the application server. The delay on a Wi-Fi link may change over time depending on the interference generated by other nearby Wi-Fi networks operating within the same frequency band. Similarly, the delay between the UPF and the application server (AS) depends on the location of the selected UPF, the selected edge/AS and on the network congestion level. Therefore, measurements may be used to estimate these time-varying delays on the non-5G segments.

There is thus provided an efficient implementation the determination of delays across the non-5G segments of the E2E path between a glasses endpoint and an AS, or alternatively, an edge AS (EAS) for split-rendering.

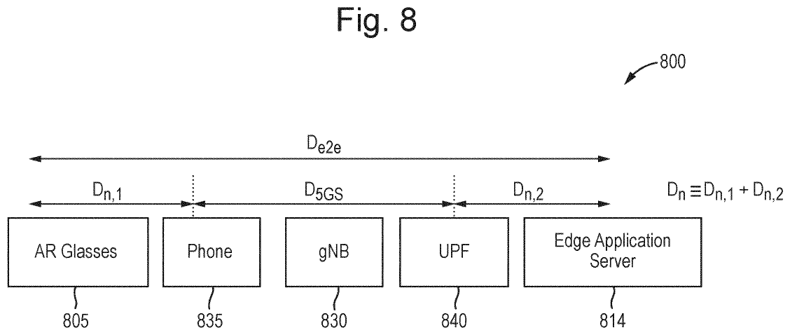

FIG. 8 illustrates an E2E path and subsequent path delays. In this example, the E2E path comprises AR glasses 805, a phone 835, a gNB 830, a UPF 840, and an Edge Application server 814. The delay notation illustrated in FIG. 8 is defined as follows.
Dₑ₂ₑ: denotes the E2E delay in one direction, i.e., either UL or DL.
D_{5GS}: denotes the 5GS delay from the PSA UPF to the UE, which is measurable by means of core network QoS monitoring procedures described in 3GPP TS 23.501 and RAN Layer 2 measuring procedures described in TS 38.314; this can be measured both based on average performance of DRBs and QoS flows, but also per QoS flow and per DRB per UE. For the latter, per QoS flow per UE QoS monitoring procedure is applied leveraging the GTP-U headers to carry the timestamps necessary for PSA UPF to NG-RAN measurements, whereas the delay between NG-RAN to UE is measured on average per DRB per UE conform RAN Layer 2 procedures at PDCP layer.
D_{n,1}: denotes the tether link (e.g., Wi-Fi, Bluetooth) delay.
D_{n,2}: denotes the DN link (e.g., connection between PSA UPF and AS, or alternatively, EAS) latency.
Dₙ: denotes the total non-5G/non-3GPP E2E delay accumulated over the tethered link and the DN link segments as Dₙ=D_{n,1}+D_{n,2}.

It is therefore useful to determine Dₙ so as to allow fine control of D_{5GS} by means of QoS rules such that the delay budget and requirements of an application, i.e., D_{e2e,max} is met, i.e., Dₑ₂ₑ=D_{5GS}+Dₙ≤D_{e2e,max}.

The delay measurement can thus be either performed on a segment-by-segment basis, whereby the delays detailed above are determined individually and because of interest is the determination of D_{n,1} and D_{n,2} delays.

For delay measurement, the measured delay may be representative of the delay to be experienced by data packets passing between the AR glasses 805 and the edge application server 814. Delay measurements based on out-of-band delay measurement messages such as the ping message (ICMP Echo and Echo Reply, according to RFC 792) may be easy to collect yet may not accurately reflect the delay experienced by the data packets. The latter is a consequence of two facts: i). the delay measurement ICMP message uses a protocol number (e.g., 1 for ping) that is different from the protocol number of an XR traffic data packet (e.g., 17 in case data packets are sent with RTP/UDP), and this results in different 5-tuples (src addr, dst addr, src port, dst port, protocol id), and consequently different QoS treatment in the 5GS communications links; ii). the packet size of a ICMP delay measurement typically is much smaller than that of a data packet (couple of tens of bytes), resulting in different transmission delays.

An alternative approach to delay measurement is represented by in-band delay measurements performed on top of the RTP/UDP stack, WebRTC stack, RTP/QUIC stack, WebRTC/QUIC stack or alike real-time communications protocols. This utilizes in some implementations RTP header extensions, e.g., WebRTC/RTP abs-send-time header extension (http://www.webrtc.org/experiments/rtp-hdrext/abs-send-time), and time synchronization relative to an NTP server to measure the delay at the receiver, or alternatively, at a network node along a network path, from the absolute sent time of an RTP packet, or alternatively, RTP packets enclosing an ADU. In another implementation, piggybacking on top of RTCP sender/receiver reports may be utilized together with RTP/RTCP multiplexing as per RFC 5761 for unicast sessions. In this case the RTP timestamps together with the RTCP sender/report inter-timestamps and receive times can be used to calculate an average round-trip time (RTT) and provide an estimate for the latter, for the UL, or alternatively, for the DL direction.

In case of in-band delay measurement the measurement framework requires an E2E measurement approach coupled with 5GS measurement procedure for the determination of Dₑ₂ₑ, D_{5GS}, and ultimately of the measurement of interest, i.e., Dₙ. This fact is due to the piggybacking strategy on top of RTP traffic originating from the application source.

3GPP has also defined in TS 23.288 v17.2.0 an architecture to support providing network analytics. In the architecture, the NWDAF provides analytics outputs to one or more Analytics Consumer NFs based on Data Collected from one or more Data Producer NFs. The Analytics Consumer NF may be one or more of an AF, OAM and 5G Core NFs (e.g., SMF, AMF, PCF).

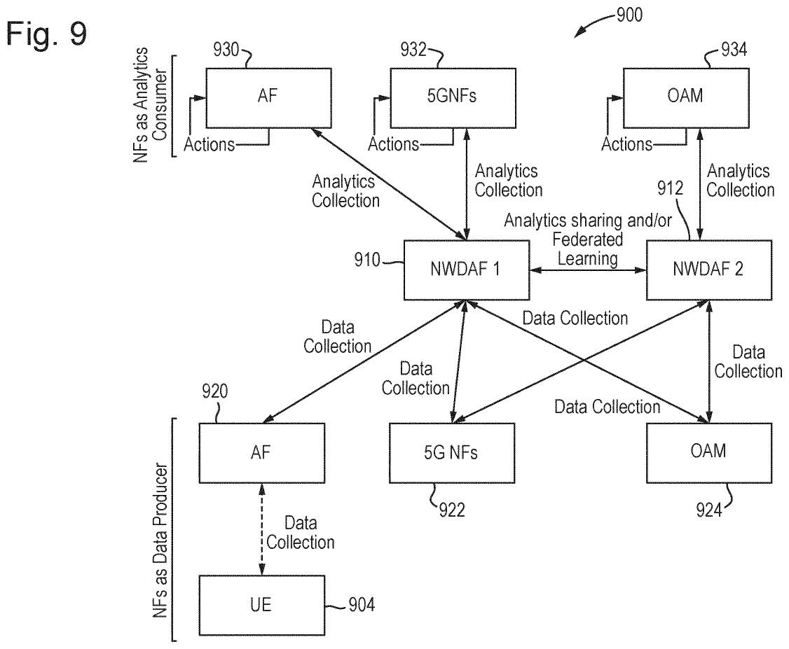

FIG. 9 illustrates an example wireless communication system 900. The system 900 comprises a UE 904 an NWDAF Analytics Logical Functions (ANLF) 910, an NWDAF Model Training Logical Function (MTLF) 912, a plurality of Data Producer Network Functions, in this example am Application Function (AF) 920, a 5G Network Function 922, and an Operations, Administration and Maintenance (OAM) 924. The wireless communication system 900 further comprises a plurality of Analytics Consumer Network Functions which in this example include an Application Function 930, a 5G Network Function 932, and an OAM 934. In the current 3GPP architecture, the NWDAFs 910, 912 (defined in 3GPP Technical Specification 23.288 v17.2.0) provide analytic output to one or more of the Analytics Consumer NFs 930, 932, and 934 based on data collected from one or more Data Producer NFs 920, 922 and 924. The analytic output may be derived by the NWDAFs 910, 912 using Analytics sharing and/or Federated Learning. The UE 904 may be embodied as a remote unit 102, a user equipment apparatus 200, or alternatively a tethered UE 1110 as described herein. The NWDAF 1 910 and NWDAF 2 912, may be embodied as a network unit 104, and a network node 300 as described herein.

A list of potential Analytics Consumer NF for each Analytics output the NWDAF provides is described in table 1 below.

TABLE 1
Example Analytics Consumer NFs

| NWDAF Analytics Output | Example Analytics Consumer NF |
|---|---|
| Slice Load Level | PCF, NSSF |
| Observed Service Experience | PCF, OAM |
| NF load analytics | All 5G core NFs, OAM |
| Network Performance Analytics | PCF, NEF, AF, or OAM |
| UE Mobility Analytics | AMF, SMF |
| UE Communication Analytics | AMF, SMF, PCF |
| Expected UE behavioural analytics | AMF, UDM, AF or OAM |
| Abnormal behaviour analytics | AMF, SMF, PCF |
| User Data Congestion analytics | NEF, AF |
| QoS Sustainability Analytics | AF |

To support XR services and applications, the following analytics are relevant to this disclosure. Such analytics can be beneficial for mobile XR users, or for the XR service providers who need to deploy the XR service in a target area and time (e.g., for an event) and requires the statistics/predictions on the QoS/network performance and availability.
QoS Sustainability Analytics: Provides information regarding the QoS change statistics for an Analytics target period in the past in a certain area or the likelihood of a QoS change for an Analytics target period in the future in a certain area.
Network Performance Analytics: Provides either statistics or predictions on the gNB status information, gNB resource usage, communication performance and mobility performance in an Area of Interest.
User Data Congestion Analytics: User Data Congestion related analytics can relate to congestion experienced while transferring user data over the control plane or user plane or both.
DN Performance Analytics: Provides statistics or predictions on the DN performance indicators for a specific edge computing application for a UE, group of UEs over a specific serving PSA UPF, DN application identifier or EAS.

In Release 17 the framework for UE data collection and reporting framework for event exposure (EVEX) has been completed. This provides the architecture and protocols for enabling the collection of UE and AS data and exposure of associated events to NF consumers through the generic architecture and procedures described by NWDAF.

To this end, the high-level procedures by which data is collected by a NWDAF from UE application(s) via an intermediary AF as data provider are exploited. This is achieved by a Data Collection AF (DCAF) which is registered with the NRF and connected as an event provider to the NWDAF. The DCAF relies on three possible Data Collection Clients:
a Direct Data Collection Client that operates directly on the UE endpoint and collects data relevant to the application operation and logic directly communicating with an instance of the DCAF;
an Indirect Data Collection Client that operates within an ASP backend with whom the UE application instance communicates collected data; the Indirect Data Collection Client collects the UE application data and relays it further to a DCAF instance; and/or
an AS/EAS which communicates with the DCAF as part of an ASP infrastructure, or via the NEF interfaces in distributed/separate domains deployments.

The DCAF and subsequently the Data Collection Clients may thus be provisioned by the Application Service Provider via a provisioning AF with a configuration meant to perform data collection directly from one UE or a group of UEs serving the application, or alternatively, from the AS/EAS serving application content to the one UE or the group of UEs. The configuration further comprises a Data Access Profile provisioned by the application provider. The Data Access Profile contains information about the data parameters to be collected (e.g., an Event ID), filtering metadata to apply to the collected data (e.g., location filters, time sampling restrictions, UE/application identifier filters etc.), and the reporting procedures. The Data Access profile may also define the processing to be performed by the DCAF of the collected data for generation and exposure of events to further NF, or alternatively, AF.

The DCAF is thus connected as a NF data producer, or alternatively event producer, with an NWDAF instance which is an event consumer. Further event consumers can be attached by means of the NWDAF service-based architecture. For instance, other event consumers may be other NFs, such as PCF, SMF, UPF or alike, or other AFs, like the application provider AF.

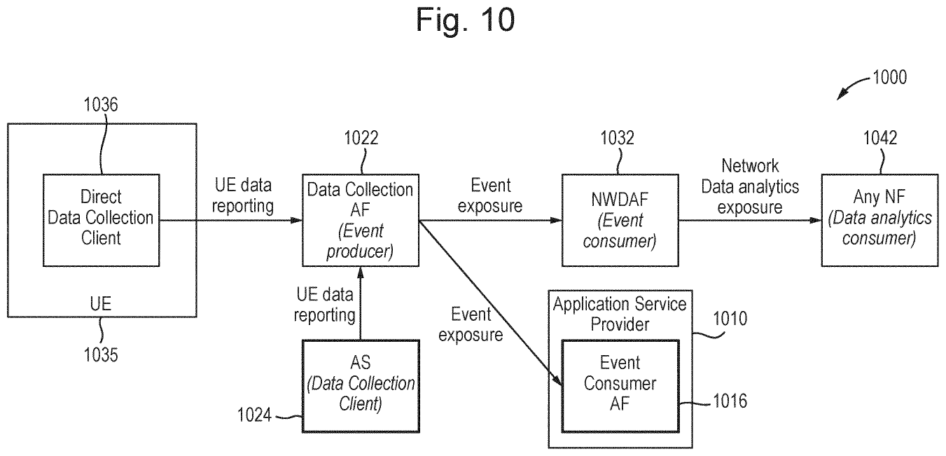

FIG. 10 illustrates a generic DCAF architecture depicted in simplified format. The NRF registration and provisioning AF connections of the DCAF are left out for brevity. A wireless communication device 1035 comprises a Direct Data Collection Client (DDCC) 1036 which reports to a Data Collection Application Function (DCAF) 1022. DCAF 1022 receives UE reporting data also from an Application Server 1024 and exposes an event to both an NWDAF 1032 and an Event consumer application function 1016 in an ASP 1010. NWDAF 1032 exposes network data analytics to any network function 1042 that wishes to consume data analytics. As such, the DCAF 1022 collects data over a configured data collection session (i.e., by means of a Data Access Profile acquiring data over a RESTful APIs served over HTTPS authenticated connections) with the Direct Data Collection Client 1036 and the AS 1024, which may be an Edge AS. The collected data is processed at the DCAF 1022 to generate and expose an event which is further consumed by the NWDAF 1032 for analytics. The NWDAF 1032 in turn performs analytics on the collected events and outputs the results to other NF/AF consumers 1042.

The Data Access Profile is defined in TS 26.531 v17.0.0 “Data Collection and Reporting; General Description and Architecture”. Various restrictions along the time, user, and location dimensions, are available.
Restrictions along time: determine granularity of access to UE data along the time axis. The finest granularity allows access to events as they take place in time (no restriction). The coarsest level of access aggregates all event data along the time axis to produce a single aggregated value given an aggregation window.
Restrictions along users: allow the provisioning AF to restrict access to UE data related events based on groups. The finest granularity allows the event consumer to access events related to single users, or alternatively, UEs. Coarse granularity access exposes aggregated collected event data based on user groups, as defined by an application (e.g., UEs that run a certain application version). The coarsest granularity access exposes the data being aggregated for all users.
Restrictions along location: allow the Provisioning AF to restrict access to UE data related events based on geographical location of the data collection client during the event. The finest granularity allows the event consumer to access events individually, irrespective of the location. Coarse granularity access exposes aggregated collected event data based on a geographical area. The coarsest level of access aggregates all event data along locations to produce a single aggregated value for all locations.

The baseline set of aggregation filters for the DCAF is defined currently in 3GPP TS 26.532 v17.1.0 “Data Collection and Reporting. Protocols and Formats”, in particular at Table 4.5.2-1. The baseline DCAF aggregation filters based on reporting period is thus as follows:
None: no aggregation applied, all reported data records are exposed as individual events.
Count: number of reported data records is exposed to event consumers
Mean: mean average of the values in reported data records is exposed to event consumers.
Maximum: maximal observed value in reported data records is exposed to event consumers.
Minimum: minimal observed value in reported data records is exposed to event consumers.
Sum: sum of the values in reported data records is exposed to event consumers.

In 3GPP a framework for Service Enablement Application Layer (SEAL) in support of Vertical Application Layers (VAL) has been developed over the past several releases. As such SEAL is organized as a generic SEAL service functional model instantiated by specific SEAL service functional models, such as:
Location management;
Group management;
Configuration management;
Identity management;
Key management;
Network resource management
Data delivery, and
Application Data Analytics Enablement (ADAE)

The generic functional model for the SEAL is organized into generic functional entities based on the client-server architecture to describe a functional architecture which addresses the application layer support aspects for vertical applications for both on-network (based on Uu connectivity) and off-network (based on PC5 connectivity).

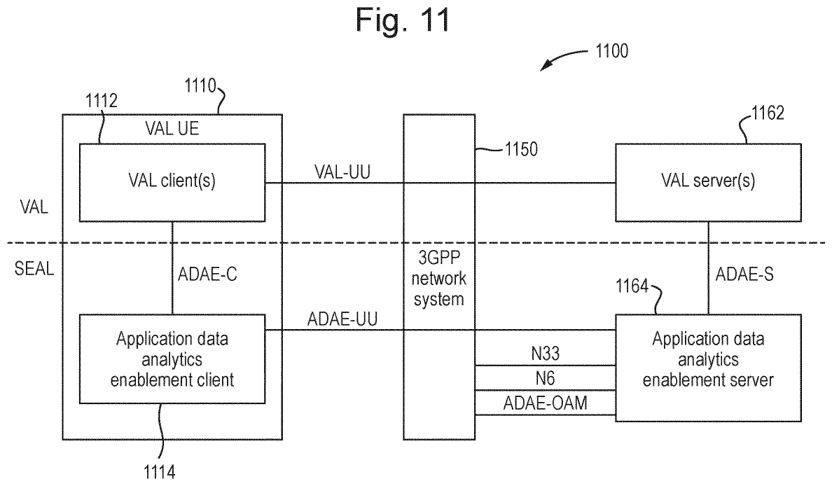

ADAE layer is one new SEAL service which is specified in 3GPP TS 23.436 v0.3.0 “Procedures for Application Data Analytics Enablement Service”. FIG. 11 is a reproduction of Figure 5.2.2-1 of TS 23.436 and depicts the application data analytics enablement architecture 1100 in the non-roaming case, using the reference point representation showing how various entities interact with each other.

The architecture 1100 comprises a VAL UE 1110 which communicates via a 3GPP network system 1150 with a VAL server 1162 and an Application data analytics enablement server (ADAES) 1164. The VAL UE 1110 comprises a VAL client 1112 and an Application data analytics enablement client (ADAEC) 1114. The communication protocols between components of the architecture 1100 are illustrated in the figure. The architecture 1100 can be considered as comprising a VAL-side and a SEAL-side. The VAL-side is illustrated as the upper part of FIG. 11, and the SEAL-side is illustrated as the lower part of FIG. 11.

In operation, the application data analytics enablement client communicates with the application data analytics enablement server over the ADAE-UU reference point. The application data analytics enablement client provides the support for application data analytics enablement functions to the VAL client(s) over ADAE C reference point. The VAL server(s) communicates with the application data analytics enablement server over the ADAE-S reference point. The application data analytics enablement server, acting as AF, may communicate with the 5G Core Network functions (over N33 reference point to NEF and N6 reference point to UPF) and OAM (over ADAE-OAM interface).

In ADAE framework, A-DCCF and A-ADRF can be defined as functionalities within the ADAE architecture and can offer the following functionalities:
Application layer-Data Collection and Coordination Function (A-DCCF) coordinates the collection and distribution of data requested by the consumer (ADAE server). Data Collection Coordination is supported by a A-DCCF. ADAE server can send requests for data to the A-DCCF rather than directly to the Data Sources. A-DCCF may also perform data processing/abstraction and data preparation based on the VAL server requirements. A-DCCF can be within the ADAE framework or in certain implementations as external data coordination functionality (e.g. SEAL entity, core entity)
Application layer-Analytics and Data Repository Function (A-ADRF) stores historical data and/or analytics, i.e., data and/or analytics related to past time period that has been obtained by the consumer (e.g. ADAE server). After the consumer obtains data and/or analytics, consumer may store historical data and/or analytics in an A-ADRF. Whether the consumer directly contacts the A-ADRF or goes via the A-DCCF is based on configuration.

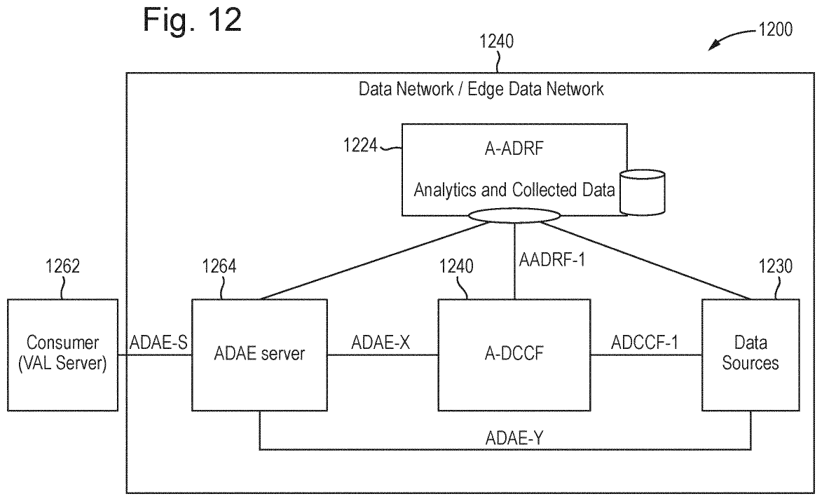

FIG. 12 illustrates a generic functional model 1200 for ADAE when re-using the 3GPP network data analytics model. An Application layer-Analytics and Data Repository Function (A-ADRF) 1224 stores analytics and collected data in a storage component associated therewith. The architecture 1200 further comprises at least one data source 1230, an Application layer-Data Collection and Coordination Function (A-DCCF) 1240, an ADAE server 1264 and an analytics consumer 1262. A data network 1240 (which may be an edge data network) comprises the A-ADRF 1240, the at least one data source 1230, the A-DCCF 1240, and the ADAE server 1264.

In this model, the A-DCCF 1240 is used to fetch data or put data into an application-level entity (e.g. A-ADRF 1224, Data Source 1230). Such A-DCCF 1240 coordinates the collection and distribution of data requested by the ADAE server 1264 (over ADCCF-1, ADAE-X). The ADAE server 1264 can also directly interact with the Data Sources via ADAE-Y.

Also, the Application layer-Analytics and Data Repository Function (A-ADRF) 1224 can be used to store historical data and/or analytics, i.e., data and/or analytics related to past time period that has been obtained by the ADAE server 1264 (via AADRF-1) or other NFs/NWDAF. ADAE server 1264 can also fetch historical data from ADRF 1224. Whether the ADAE server 1264 directly contacts the ADRF or goes via the A-DCCF 1240 is based on configuration.

Data Sources 1230 can be 5GS data sources (5GC, OAM) or enablement layer data sources (SEAL, EEL) or external data sources at the DN side (VAL server/EAS) and VAL UEs. The A-DCCF 1240 and the A-ADRF 1224 can be used only for interacting with certain data sources (e.g., 5GC, OAM) based on configuration, and can be hidden from the VAL layer.

There is presented herein a mechanism for analyzing the delay for application layer segments within an end to end application service (e.g. XR service) segment, and in particular the link between the Application Client at the Tethered Device, and the 3GPP UE (in particular a 5G UE). Based on this analysis, the mechanism includes the derivation of application layer statistics or predictions for the segment of interest and the optional recommendation of an action towards the consumer (e.g. VAL server or VAL client, NF such as NWDAF, DCAF). The steps of this solution are defined in the following numbered paragraphs.
1. A consumer subscribes to the application service enabler (ADAES or in general a SEAL server/EES) for a monitoring or analytics event related to the segment of interest (e.g. Link X: tethered device-5G device).
2. The application service enabler sends the requirement to the 5G device, and in particular a client application at the 5G device (namely service enabler client, or ADAEC, or SEAL client), and configures the device to collect or calculate the data and report and certain criteria (e.g. by providing pre-defined thresholds for triggering an action).
3. The 5G device starts collecting data from one or more application clients (via request/response, or subscribe/notify) at one or more tethered devices. Such collection may comprise at least one of the following options:
   Alt1: requesting app client the end-to-end delay past measurements. The enabler client is able to identify the segments between 5G device and application service enabler; hence it can calculate the remaining delay contribution.
   Alt2: by knowing the relative location of the tethered UE and the technology used, it can estimate the maximum and minimum latency given NLOS and LOS accordingly.
   Alt3: if one or more Apps of the tethered UE interact with the 5G device, the 5G device can capture when the delay for the link exceeds the packet delay budget and for how much time (for example for Link X, the PDB may be 5 ms and XR message arrives at the 5G device in 7 ms).
   Alt4: the 5G device (using the analytics enabler) perform local analytics based on the tethered UE location and the technology as well as the environment and the time of the day. Such analytics can be AI/ML-based.
4. The 5G device sends the collected data (measurements or analytics) in the form of a report to the application service enabler for the one or more tethered devices. Such report can be provided one time or regularly or based on an event (e.g. delay deviation).
5. The application service enabler derives analytics based on the data. Such analytics can take the following forms:
   Statistics or predictions for a given time horizon on the delay for the segment of interest per link or per tethered UE or per 5G device.
   Statistics or predictions for the end-to-end delay considering inputs from both 3gpp and non-3gpp links.
   Whether delay for the segment of interest can be sustainable for a given session or time period.
6. Based on the analytics, the service enabler may also recommend a pro-active action towards the VAL customer or the 5G network. Such action can be based on certain policies (trigger event-action pair) or the service enabler may have the logic to translate the predictive event to an action of the VAL service.
   Towards VAL server, the action can be the adaptation of the service mode/level (e.g. video resolution, level of automation) for the application to cope with possible high delays. This can include also additional adaptations, such as the change of traffic schedules or different retransmission policies (from app layer)
   Towards the 5GC, such action can be the update of QoS requirements/profile per network session to compensate with high potential delays due to the high delays at the segment of interest (tethered UE to 5G device). Additional action may be the request to update the UP path (to perform traffic steering) or possible change of slice (which can offer lower delays).
7. The service enabler sends the analytics output based on the subscription to the consumer.

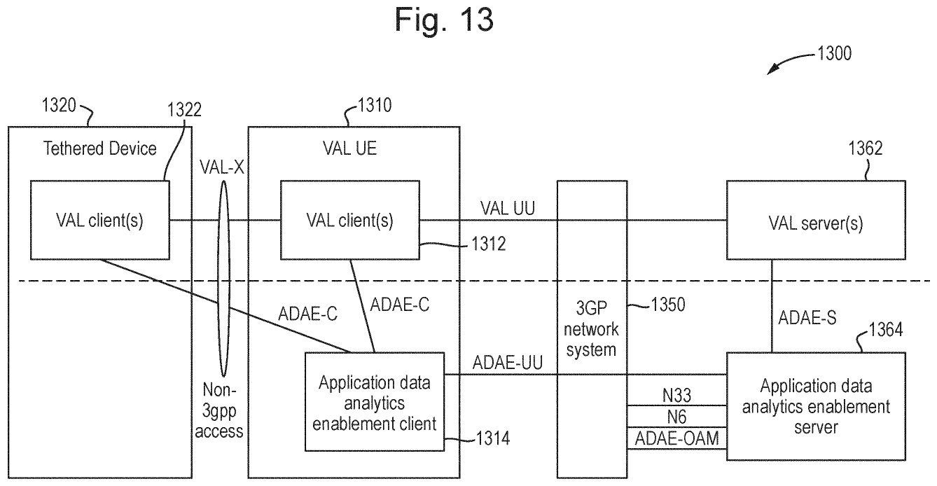

FIG. 13 illustrates an architecture 1300 that provides a mechanism for the case where the analytics is needed for ADAE-C interface and the VAL client resides at a different UE which is not networked. Such cases may exist for:
Tethering in XR scenarios
Industrial scenarios where the VAL client resides at a local cloud, and the UE is a low capability node (e.g. a field device or slave). In such scenario, the interaction between the slave/field device and local cloud can be via other wireless technology (e.g. wifi)
Constrained devices (e.g. sensors) which may not run applications at the same entity but in another entity (e.g. UE GW for a group of devices), the interaction of the GW and the VAL UE can be via non-3gpp wireless means.

The architecture 1300 comprises a VAL UE 1310 which communicates via a 3GPP network system 1350 with a VAL server 1362 and an Application data analytics enablement server (ADAES) 1364. The VAL UE 1310 comprises a VAL client 1312 and an Application data analytics enablement client (ADAEC) 1314. The VAL UE 1310 is tethered to tethered device 1320 by a non-3GPP access link. The non-3GPP access link may comprise Bluetooth or Wi-Fi. The tethered device 1320 comprises a VAL client 1322. The communication protocols between components of the architecture 1300 are illustrated in the figure. The architecture 1300 can be considered as comprising a VAL-side and a SEAL-side. The VAL-side is illustrated as the upper part of FIG. 13, and the SEAL-side is illustrated as the lower part of FIG. 13.

A pre-condition for the operation of the architecture 1300 is that the ADAEC 1314 is connected to ADAES 1364. The steps of this solution are defined in the following numbered paragraphs.
Step 1: The VAL server 1362 sends a subscription request to ADAES 1364 for ADAE-C/VAL-X 1314 performance analytics. In this request the VAL server 1362 indicates the service ID/application ID the VAL UE id and address, the tethered device identity (or information), the type of connectivity for ADAE-C 1314 as well as for VAL-X (e.g. Wifi), optionally the location of tethered device (if it is assumed fixed), the analytics type (e.g. delay sustainability or predicted delay or delay stats), the service area, time of validity and possibly the preferred confidence level (in case of prediction). It may be possible that the UE is not indicated, and the subscription is for all UEs in a given service area (e.g. XR users)
Step 2: The ADAES 1364 authorizes the request and send a subscription response as a positive or negative result
Step 3: The ADAES 1364 find the VAL UEs that need to provide reports as well as the data sources needed for data collection. The data sources can be:
   A-ADRF which may keep historical data/analytics related to ADAE-C/VAL-X interface delay for the given UE or for the given service and area/time.
   VAL client 1322 of the tethered device 1320 which can provide QoS data (delay) for the link or end to end.
   VAL client 1312 of the VAL UE 1310 which supports the connectivity.
Step 4: The ADAES 1364 sends a request to ADAEC 1314 for performance data for ADAE-C and/or VAL-X, indicating the reporting configuration parameters (frequency, intervals, . . . ), trigger criteria for the reporting (e.g. thresholds for upper tolerable delay), processing required (abstraction, analytics/statistics), the data sources which are needed to provide data and time validity for the request.
Step 5: The ADAEC 1314 identifies whether it is possible to collect the requested data, and if it is feasible it responds to ADAES 1364 with a positive or negative acknowledgement.
Step 6: The ADAEC 1314 starts collecting data from the data sources. In case of A-ADRF the ADAEC subscribes directly to A-ADRF or via ADAES.
Step 7: Based on the reporting configuration, and the data requirement, the ADAEC provides the data/analytics related to the performance of ADAE-C and/or VAL-X, to ADAES. Such data may be the expected/actual/predicted/statistical delay for the link/segment of interest or the deviation/delta from the upper bound.
Step 8: The ADAES 1364, upon receiving the data, derives analytics on the VAL-X/ADAE-C predicted performance. To do that, ADAES 1364 may optionally obtain supplementary data on the location of the VAL UE 1310 and the tethered device 1320 to help predicting the delay more accurately.
Step 9: The ADAES 1364 may also provide a recommendation on the pro-active action based on the analytics. This requires that the ADAES 1364 has the logic for such translation, or it may utilize another SEAL service (or input from VAL server) to identify what is the best action based on the predictive trigger.
Step 10. The ADAES 1364 sends an analytics notification and optionally a pro-active adaptation towards a network entity and/or an application entity.

The integration of analytics regarding to the Data Network performance of the application within the SEAL plane may be desirable. Such integration may support the implementation of over-the-top vertical immersive, and/or interactive media applications, e.g., XR applications, experienced by end users through tethered UEs, e.g., as a combination of a HMD and a 5G device or alike.

As such, the QoS delay characteristics at the application layer, E2E across all network segments may be monitored and controlled to provide support and reliable experience to over-the-top vertical immersive and interactive media applications experienced over tethered UEs. In such arrangements the SEAL ADAE service may monitor the connectivity of the VAL across all network segments:
Over the DN link segment, i.e., from the VAL server to the 5GS PSA UPF;
Over the 5GS link segment, i.e., from the 5GS PSA UPF to the tethered UE (i.e., the 5G device); and/or
Over the UE tethering link segment, i.e., from the 5G device offering the 5G DN connectivity to the tethered end-user device where the VAL application experience is consumed.

The ADAE may require novel enhancements to its support for application performance analytics, whereby the simultaneous monitoring, analytics and prediction of the data connectivity pipeline is from both a tethered UE, or alternatively, a VAL client perspective, and a AS/EAS, or alternatively, a VAL server perspective.

A tethered UE DCAF implementation may be provisioned to expose events of at least one of the type E2eDelayExperience, TetheredLinkDelayExperience, and DnDelayExperience and attached as a Data Source to the SEAL ADAE functional architecture. The new events exposed to the ADAE are thus based on the Dₑ₂ₑ, D_{n,1}, D_{n,2} delay measurements collected by the tethered UE Direct Data Collection Client, or alternatively, VAL client, and by the AS/EAS, or alternatively, VAL server. As such, the ADAES acts as a consumer AF exposed to the events outputs of the DCAF. This tethered UE specific ADAE data source supplements thus the other ADAE data sources, i.e., the VAL server, 5GS data sources and the enablement layer data sources (e.g., SEAL, Edge Enablement Layer (EEL)).

The tethered UE Direct Data Collection Client may be instantiated and implemented by an ADAE Client (ADAEC) co-located within tethered UE device with the MAF, or alternatively, the MSH.

An ADAE connected to the tethered UE DCAF can extend its support for application performance analytics to additionally include tethered UE analytics, as a tethered VAL client. These analytics may be extended to include online analytics for real-time analytics and predictions to the VAL server to consume. Such ADAE functionality may be identified by the Analytics ID “tethered VAL connectivity performance”.

The VAL server consuming ADAE tethered VAL connectivity performance analytics may adapt its behavior (e.g., application layer configuration adaptation, source coding rate reduction, video encoding configuration changes in terms of FPS, Q-parameter, number of slices, number of layers, number of eye buffers, or similarly, audio encoding configuration change to a lower encoding quality, AS/EAS load balancing etc.), or request a network resource management to the SEAL NRM instance for adaption of the QoS treatment based on the ASP application requirements.

In the former case, an example may include the VAL server throttling down the FPS of the video traffic associated with an XR application from 120 FPS to 60 FPS when the ADAES predicts an increase of delay E2E by means of monitoring any of the events exposed by the tethered UE via the corresponding ADAEC.

In the latter case, an implementation may include the VAL server determining the 5GS network provider to adapt the 5GS QoS delay budget and lower it from a previous PDB setting of D_{c,1} to a lower PDB setting of D_{c,2}, such that D_{c,2}+D_{n,1}+D_{n,2}≤Dₑ₂ₑ, max, where the Dₑ₂ₑ, max is the maximum threshold of E2E delay tolerated by the ASP application and VAL server. In such a case, the VAL server request to SEAL layer for adaptation of the QoS delay budget parameters over the 5GS is based on the interaction of the VAL server with the NRM server, whereby the VAL server performs a network resource adaption request to the NRM server to lower the QoS delay budget within the limits allowed by an SLA between the ASP and a mobile network operator or 5GS service provider. In one example, such a request may contain the VAL server requester identity, a list of one or more tethered VAL UE IDs and a resource adaptation requirement indicating the VAL service requirement for the new QoS delay budget (e.g., 10 ms as either PDB, or alternatively, PSDB) for the QoS flows related to the VAL service flows of interest. The NRM will perform the adaptation procedure given that the VAL server is authorized to request such a change and report back the status of the update (i.e., successful including the changed parameters, or failed and an appropriate failure code).

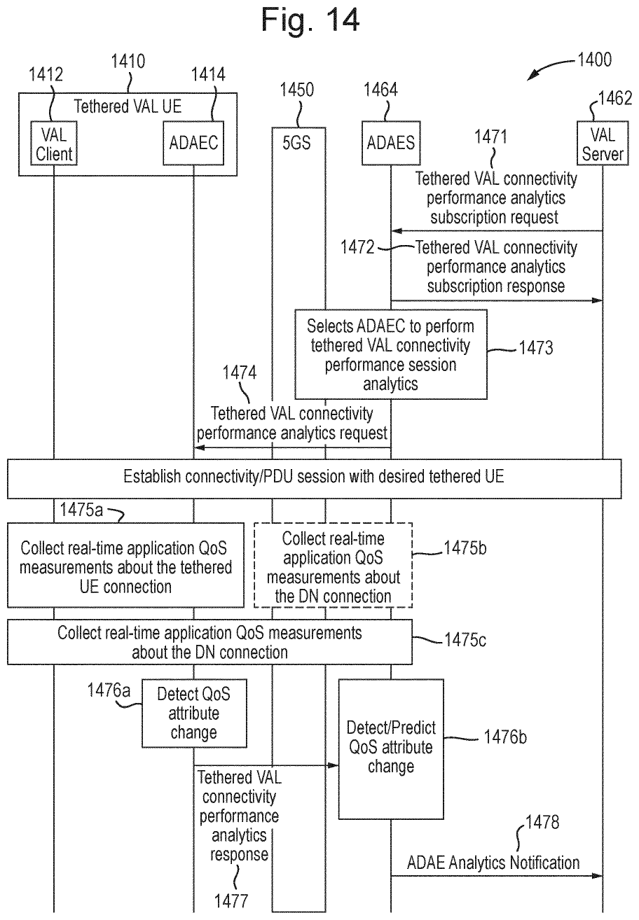

The procedure associated with the ADAE analytics for tethered UE and application connectivity performance is described below as depicted in FIG. 14, whereby the connection between an ADAEC and ADAES is established.

FIG. 14 illustrates a Tethered VAL connectivity performance analytics procedure 1400. The procedure 1400 is implemented by a tethered VAL UE 1410, a 5G System 1450, an ADAES 1464, and a VAL server 1462. The tethered VAL UE 1410 comprises a VAL client 1412 and an ADAEC 1414.

The procedure 1400 begins at 1471, when the consumer of the ADAES analytics service, e.g., the VAL server 1462, sends a subscription request to ADAES 1464 and provides the analytics event ID e.g., “tethered VAL connectivity performance”, the target tethered VAL UE ID or group of tethered UE IDs, the VAL session/service IDs associated with the tethered VAL UE ID, the time validity and area of the request, the required confidence level of any predictions, and the exposure level for providing UE to UE analytics. Such request can also include whether the analytics notification shall be periodic or based on an expected application ASP QoS performance, whereby the performance thresholds may be additionally provided at the request (e.g., Maximum Tether Link Delay=15 ms).

At 1472, the ADAES 1464 sends a subscription response as an ACK to the consumer (the VAL Server 1462).

At 1473, the ADAES 1464 maps the analytics ID (i.e., tethered VAL connectivity performance) to a list of data collection event identifiers, and optionally a list of data producer IDs. Such mapping may be preconfigured by the ADAES 1464 itself based on ASP preferred event types, or VAL type, or alternatively may be preconfigured by an MNO by means of the OAM. In addition, the ADAES 1646 determines, based on the configured tethered VAL UE ID and VAL session/service IDs, the instance of the ADAEC 1414 authorized to perform the tethering link related data collection and reporting. The tethering link related data collection and reporting is based on the EVEX procedures involving the tethered UE DCAF reporting mechanisms.

At 1474, the ADAES 1464 sends a tethered VAL connectivity performance analytics request to the determined tethered VAL ADAEC 1414 with the analytics event ID and the configuration of the reporting required (e.g., periodic, based on maximum delay threshold etc.). Such request also includes additional application QoS attributes to be analyzed additionally based on other metrics (tethered link delay, E2E delay, 5GS PER, 5GS PDB/PSDB etc.). An application session then starts between the tethered VAL UE 1410 and the VAL server 1462.

The next steps may happen asynchronously and in parallel given the 5GC service-based architecture and reporting of events for the configured data collection. As such the order of the events given below is merely an implementation example.

At 1475a, the ADAEC 1414 starts collecting data from the tethered VAL UE 1410 based on the request. The collection and reporting is based on the EVEX UE data collection procedures associated with mapped Event IDs of the tethered UE link performance. In such cases events such as and may collect various events related to tethered link delay, e.g., Event ID=TetheredLinkDelayExperience. This data can thus be about the delay measurements, throughput (e.g., max WiFi capacity), QoE measurements, etc. The data can be collected in part by the ADAEC 1414 from the VAL client application 1412 as well as based on the EVEX data collection and reporting procedure (e.g., as for TetheredLinkDelayExperience).

At 1475b, the ADAES 1464 can optionally further collect data about the DN performance analytics by means of NWDAF events consumption including metrics about the average/maximum packet delay between the VAL server and the serving PSA UPF, QoS monitoring analytics over the 5GS, including service experience analytics etc.

At 1475c, in addition, the ADAES 1464 may optionally collect data about the DN performance analytics by means of NWDAF events consumption including metrics about the average/maximum packet delay E2E between the VAL server and the tethered VAL UE 1410 as well as other E2E metrics related to the QoS monitoring analytics (e.g., aggregate E2E PER, etc.).

At 1476a, the ADAEC 1414 detects an application QoS change. Such a change can be for example a change in the QoS attributes requirements by means of detecting an event where the maximum latency threshold (e.g., over the tethered link or E2E) accepted by the ASP is exceeded, whereas the detection mechanism is performed over a given time horizon based on the analytics subscription request.

At 1476b, the ADAES 1464 either detects or predicts an application QoS change. Such a change can be for example a change in the QoS attributes requirements by means of detecting, or alternatively, predicting (based on collected metrics) an event where the maximum latency threshold (e.g., over the tethered link, over the DN link, or over the E2E connectivity) accepted by the ASP is exceeded, whereas the detection mechanism is performed over a given time horizon based on the analytics subscription request.

At 1477, the ADAEC 1414 sends the analytics to the ADAES 1464 in a tethered VAL connectivity performance analytics response message.

At 1478, the ADAES 1464 sends the derived analytics notification to the consumer (e.g., VAL server 1462 or any other authorized NF/AF consumer).

Accordingly, there is provided a first network node for enabling performance analytics of a tethered connection, wherein an application session comprises an end-to-end communication session, and wherein the end-to-end communication session includes the tethered connection. The first network node comprises a processor and a memory coupled with the processor, the processor configured to cause the first network node to: receive a requirement for performance analytics for the application session; identify at least one device to serve as data collection entity for collecting data required for the performance analytics; and send a data collection requirement to the identified data collection entity, the data collection requirement including a request for performance data related to the at least one tethered connection within the application session. The processor is further configured to cause the first network node to: receive, from the data collection entity, performance data measured in accordance with the data collection requirement; derive performance analytics based on the performance data and the data collection requirement; and send the derived performance analytics.

A first network node may thus derive performance analytics that include the performance of a tethered connection. Such performance analytics are required to properly understand the end-to-end quality of service. One measure of the end-to-end quality of service may comprise an end-to-end latency. The end-to-end communication session may comprise a connection between a user equipment and an application server.

The tethered connection is thus constituent of an end-to-end communication session. The end-to-end communication session is included in an application session.

The first network node may be an application data analytics enablement server (ADAES).

The application session may include communication between a wireless communication device and an application server. The application session may comprise a plurality of links which are communicated by a plurality of access technologies. The wireless communication device may comprise a tethered device and a tethering device. The tethering device may be arranged to communicate with the tethered device via the at least one tethered connection. The tethered connection may comprise a connection using Wi-Fi or Bluetooth, for example.

Receiving a requirement for performance analytics comprises receiving a subscription request from an analytics consumer.

The derived performance analytics may be sent in response to the requirement for performance analytics to the analytics consumer. The derived performance analytics may be sent to the analytics consumer.

The requirement for performance analytics may comprise at least one of: an analytics event identity; at least one target VAL UE identity; a group identifier consisting of one or more tethering device identities and one or more tethered device identities; information on the capability and/or access technology for the tethering connection; positioning information associated with a target VAL UE identity; a VAL session identity associated with a target VAL UE identity; a VAL service identity associated with a target VAL UE identity; a period of time for which measurements should be collected; a definition of an area for which measurements should be collected; the required confidence level of any derived performance analytics; and an exposure level for providing analytics related to the tethered connection. The target VAL UE identity may include the identity of a tethered device and/or a tethering device. The derived performance analytics may comprise at least one prediction.

The processor may be further configured to cause the first network node to select at least one data source for the collection of data by the data collection entity.

The performance data may comprise historical data and/or real-time data. Real-time data is measurement data that is reported as it is collected.

The data collection requirement may comprise a subscription to at least one data source.

The application session may comprise at least one of: an extended reality session, a mobile metaverse session, and/or an artificial intelligence application session.

The performance analytics may comprise at least one of: statistics or predictions for a communication delay of the tethered connection; statistics or predictions for the end-to-end delay considering the tethered connection as well as other segments in the end to end communication session; and/or identifying whether the quality of service for the tethered connection is sustainable for a given session or time period. The performance analytics may relate to a particular time period. The particular time period may be defined. For example, the particular time period may be defined by a consumer. The consumer may comprise an application server or a network unit.

The performance analytics may be sent to an application server or to a network unit.

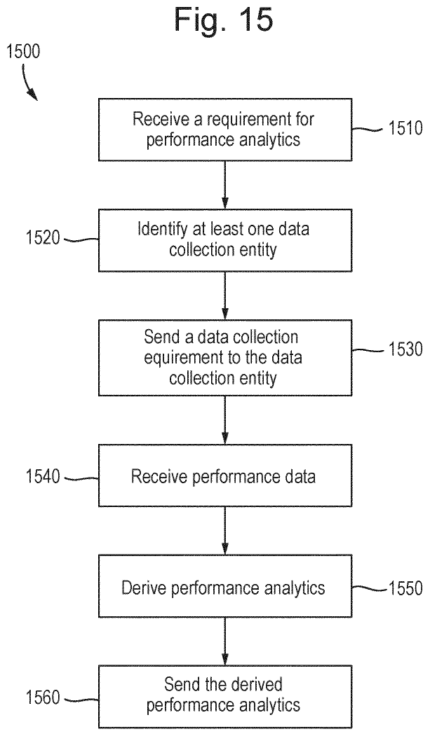

FIG. 15 illustrates a method 1500 performed by a first network node for enabling performance analytics of a tethered connection, wherein an application session comprises an end-to-end communication session, and wherein the end-to-end communication session includes the tethered connection. The method 1500 comprises: receiving 1510 a requirement for performance analytics for the application session; identifying 1520 at least one device to serve as data collection entity for collecting data required for the performance analytics; and sending 1530 a data collection requirement to the identified data collection entity, the data collection requirement including a request for performance data related to the at least one tethered connection within the application session. The method 1500 further comprises: receiving 1540, from the data collection entity, performance data measured in accordance with the data collection requirement; deriving 1550 performance analytics based on the performance data and the data collection requirement; and sending 1560 the derived performance analytics.

In certain embodiments, the method 1500 may be performed by a processor executing program code, for example, a microcontroller, a microprocessor, a CPU, a GPU, an auxiliary processing unit, a FPGA, or the like.

A first network node may thus derive performance analytics that include the performance of a tethered connection. Such performance analytics are required to properly understand the end-to-end quality of service. One measure of the end-to-end quality of service may comprise an end-to-end latency. The end-to-end communication session may comprise a connection between a user equipment and an application server.

The first network node may be an application data analytics enablement server (ADAES).

The application session may include communication between a wireless communication device and an application server. The application session may comprise a plurality of links which are communicated by a plurality of access technologies. The wireless communication device may comprise a tethered device and a tethering device. The tethering device may be arranged to communicate with the tethered device via the at least one tethered connection. The tethered connection may comprise a connection using Wi-Fi or Bluetooth, for example.

Receiving a requirement for performance analytics comprises receiving a subscription request from an analytics consumer.

The derived performance analytics may be sent in response to the requirement for performance analytics to the analytics consumer. The derived performance analytics may be sent to the analytics consumer.

The requirement for performance analytics may comprise at least one of: an analytics event identity; at least one target VAL UE identity; a group identifier consisting of one or more tethering device identities and one or more tethered device identities; information on the capability and/or access technology for the tethering connection; positioning information associated with a target VAL UE identity; a VAL session identity associated with a target VAL UE identity; a VAL service identity associated with a target VAL UE identity; a period of time for which measurements should be collected; a definition of an area for which measurements should be collected; the required confidence level of any derived performance analytics; and an exposure level for providing analytics related to the tethered connection. The target VAL UE identity may include the identity of a tethered device and/or a tethering device. The derived performance analytics may comprise at least one prediction.

The method may further comprise selecting at least one data source for the collection of data by the data collection entity.

The performance data may comprise historical data and/or real-time data. Real-time data is measurement data that is reported as it is collected.

The data collection requirement may comprise a subscription to at least one data source.

The application session may comprise at least one of: an extended reality session, a mobile metaverse session, and/or an artificial intelligence application session.

The performance analytics may comprise at least one of: statistics or predictions for a communication delay of the tethered connection; statistics or predictions for the end-to-end delay considering the tethered connection as well as other segments in the end-to-end communication session; and/or identifying whether the quality of service for the tethered connection is sustainable for a given session or time period. The performance analytics may relate to a particular time period. The particular time period may be defined. For example, the particular time period may be defined by a consumer. The consumer may comprise an application server or a network unit.

The performance analytics may be sent to an application server or to a network unit.

There is further provided a second network node for enabling performance analytics of a tethered connection wherein an application session comprises an end-to-end communication session, and wherein the end-to-end communication session includes the tethered connection. The second network node comprises a processor; and a memory coupled with the processor. The processor is configured to cause the second network node to: receive a data collection requirement from a first network node; determine at least one data source based on the data collection requirement; collect performance data from the at least one data source, the collecting based on the data collection requirement; send the collected performance data to the first network node.

A second network node may thus derive performance analytics that include the performance of a tethered connection. Such performance analytics are required to properly understand the end-to-end quality of service. One measure of the end-to-end quality of service may comprise an end-to-end latency.

The second network node may comprise an application data analytics enablement client (ADAEC). The first network node may comprise an application data analytics enablement server (ADAES).

The processor may be further configured to cause the second network node to process the collected performance data before sending it to the first network node. The second network node may comprise collecting performance data from the at least one data source, processing the collected performance data, and then sending the processed collected performance data to the first network node.

The processor may be further configured to cause the second network node to determine if the collected performance data is sufficient to satisfy the data collection requirement; and if the collected performance data is not sufficient to satisfy the data collection requirement, then request supplementary data. The supplementary data may be collected from the at least one data source or form a further data source.

The performance data may comprise an indication of a communication delay in the tethered connection.

Collecting performance data may comprise at least one of: requesting end to end delay past measurements from an application client; estimating a maximum and a minimum latency given non-line of sight and line of sight and using the relative location of the end points of the tethered connection; capturing when a delay for the tethered connection exceeds a packet delay budget; and/or performing local analytics based on the location of a tethered device, the communication technology used for the tethering connection, as well as the local environment and the time of the day.

Where collecting performance data comprises requesting end to end delay past measurements from an application client, the second network node may identify segments in the application session and calculate a remaining delay contribution.

Estimating a maximum and a minimum latency given non-line of sight and line of sight and using the relative location of the end points of the tethered connection may be based on the communication technology used for the tethered connection.

Wherein capturing when a delay for the tethered connection exceeds a packet delay budget comprises, if one or more applications use the tethered connection, the tethering device determining for how much time the tethered connection exceeds a packet delay budget (PDB).

The local analytics may be AI/ML-based.

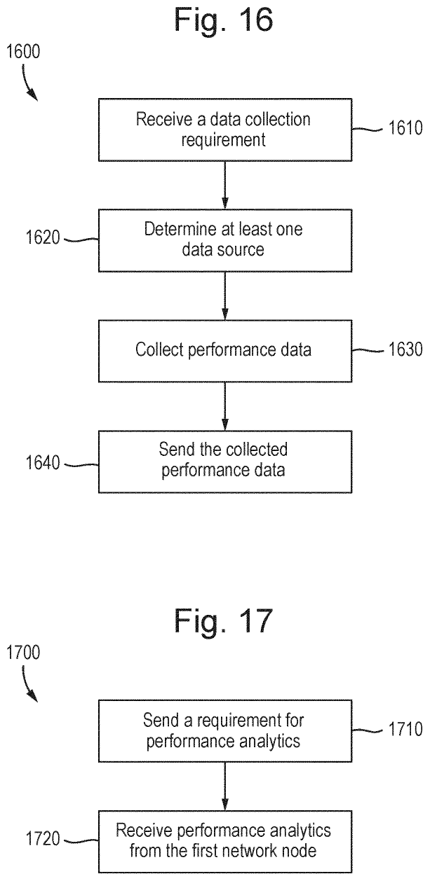

FIG. 16 illustrates a method 1600 performed by a second network node for enabling performance analytics of a tethered connection wherein an application session comprises an end-to-end communication session, and wherein the end-to-end communication session includes the tethered connection. The method 1600 comprises receiving 1610 a data collection requirement from a first network node; determining 1620 at least one data source based on the data collection requirement; collecting 1630 performance data from the at least one data source, the collecting based on the data collection requirement; and sending 1640 the collected performance data to the first network node.

In certain embodiments, the method 1600 may be performed by a processor executing program code, for example, a microcontroller, a microprocessor, a CPU, a GPU, an auxiliary processing unit, a FPGA, or the like.

A second network node may thus derive performance analytics that include the performance of a tethered connection. Such performance analytics are required to properly understand the end-to-end quality of service. One measure of the end-to-end quality of service may comprise an end-to-end latency.

The second network node may comprise an application data analytics enablement client (ADAEC). The first network node may comprise an application data analytics enablement server (ADAES).

The method may further comprise processing the collected performance data before sending it to the first network node. The method may comprise collecting performance data from the at least one data source, processing the collected performance data, and then sending the processed collected performance data to the first network node.

The method may further comprise: determining if the collected performance data is sufficient to satisfy the data collection requirement; and if the collected performance data is not sufficient to satisfy the data collection requirement, then requesting supplementary data. The supplementary data may be collected from the at least one data source or form a further data source.

The performance data may comprise an indication of a communication delay in the tethered connection.

Collecting performance data may comprise at least one of: requesting end to end delay past measurements from an application client; estimating a maximum and a minimum latency given non-line of sight and line of sight and using the relative location of the end points of the tethered connection; capturing when a delay for the tethered connection exceeds a packet delay budget; and/or performing local analytics based on the location of a tethered device, the communication technology used for the tethering connection, as well as the local environment and the time of the day.

Where collecting performance data comprises requesting end to end delay past measurements from an application client, the second network node may identify segments in the application session and calculate a remaining delay contribution.

Estimating a maximum and a minimum latency given non-line of sight and line of sight and using the relative location of the end points of the tethered connection may be based on the communication technology used for the tethered connection.

Wherein capturing when a delay for the tethered connection exceeds a packet delay budget comprises, if one or more applications use the tethered connection, the tethering device determining for how much time the tethered connection exceeds a packet delay budget (PDB).

Local analytics may be AI/ML-based.

There is further still provided a third network node for enabling performance analytics of a tethered connection within an application session, wherein the application session includes communication via at least one tethered connection. The third network node comprises a processor and a memory coupled with the processor. The processor is configured to cause the third network node to: send a requirement for performance analytics for the application session to a first network node, the requirement for performance analytics including a request for performance data related to the at least one tethered connection within the application session; and receive performance analytics from the first network node.

FIG. 17 illustrates a method 1700 performed by a third network node for enabling performance analytics of a tethered connection within an application session, wherein the application session includes communication via at least one tethered connection. The method 1700 comprises sending 1710 a requirement for performance analytics for the application session to a first network node, the requirement for performance analytics including a request for performance data related to the at least one tethered connection within the application session; and receiving 1720 performance analytics from the first network node.

In certain embodiments, the method 1700 may be performed by a processor executing program code, for example, a microcontroller, a microprocessor, a CPU, a GPU, an auxiliary processing unit, a FPGA, or the like.

A third network node may thus derive performance analytics that include the performance of a tethered connection. Such performance analytics are required to properly understand the end-to-end quality of service. One measure of the end-to-end quality of service may comprise an end-to-end latency.

The third network node may comprise an Application layer-Analytics and Data Repository Function (A-ADRF). The first network node may be an application data analytics enablement server (ADAES).

The application session may include communication between a wireless communication device and an application server. The application session may comprise a plurality of links which are communicated by a plurality of access technologies. The wireless communication device may comprise a tethered device and a tethering device. The tethering device may be arranged to communicate with the tethered device via the at least one tethered connection. The tethered connection may comprise a connection using WiFi or Bluetooth, for example.

This disclosure set presents the following novel elements: A method for providing performance monitoring and analytics at a 5GS entity for interfaces which are supported by non-3gpp connectivity. A method for introducing the ADAE service functionality for VAL tethered connectivity performance analytics which exposes to a VAL server analytics related to the performance of a tethered VAL UE and enables the application to adapt its behaviour in terms of source encoding configuration, QoS, and EAS/AS load balancing.

There is provided herein a method (which may be performed at an ADAES) for performance analytics enablement for a tethered link within an application session. The method comprises: obtaining a requirement for performance analytics for the application session, wherein the application session comprises a plurality of links which are communicated by a plurality of access technologies; identifying at least one device to serve as data collection entity for data required for the performance analytics; Sending a data collection requirement to the identified data collection entity; receiving performance data based on the data collection requirement, the performance data are related to the tethered link within the application session; deriving analytics based on the requirement; and sending the derived analytics.

Obtaining the requirement may comprise: receiving a subscription request from a consumer; and sending a subscription response.

The method may further comprise selecting at least one data source for the collection.

The performance data may include historical data or real time data.

The data collection requirement may comprise a subscription to at least one data source.

The application session may be at least one of an XR session, a mobile metaverse session, or an AI application session.

The tethered link may be communicated via technologies including Wi-Fi, Bluetooth, etc.

There is further provided a method (which may be performed in an ADAEC) for supporting performance analytics enablement for a tethered link within an application session, the method comprising: receiving a data collection requirement from an analytics enablement entity; determining at least one data source based on the requirement; collecting performance data based on the requirement from the determined data sources; sending the collected performance data to the analytics enablement entity; processing the data before sending; requesting/receiving supplementary data (location, . . . ) if data is not sufficient; performance data is the delay of the tethered link; determining the mechanism for estimating the delay of the tethered link;

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communication standards, these examples are not intended to be the limit of the communication standards to which the disclosed method and apparatus may be applied. For example, while specific examples have been given in the context of 3GPP, the principles disclosed herein can also be applied to another wireless communication system, and indeed any communication system which uses routing rules.

The method may also be embodied in a set of instructions, stored on a computer-readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field addressed by this document: 3GPP, 3rd generation partnership project; 5G, fifth generation; 5GS, 5G System; 5QI, 5G QoS Identifier; A-ADRF, application layer analytics data repository function; ADAEC, application data analytics enablement client; ADAES, application data analytics enablement server; A-DCCF, application layer data collection and coordination function; AF, application function; AMF, access and mobility function; AR, augmented reality; AS, application server; ASP, application service provider; DCAF, data collection AF; DL, downlink; EAS, edge application server; NAL, network abstraction layer; NRM, network resource management; PCF, policy control function; PDU, packet data unit; PPS, picture parameter set; PSA UPF, PDU session anchor UPF; PSB, PDU set boundary; PSI, PDU set importance; QoE, quality of experience; QoS, quality of service; RAN, radio access network; RTCP, real-time control protocol; RTP, real-time protocol; SDAP, service data adaptation protocol; SEAL, service enablement application layer; SMF, session management function; SRTCP, secure real-time control protocol; SRTP, secure real-time protocol; UE, user equipment; UL, uplink; UPF, user plane function; VAL, vertical application layer; VCL, video coding layer; VMAF, video multi-method assessment function; VPS, video parameter set; VR, virtual reality; XR, extended reality; XR AS, XR application server; and XRM, XR media.

1. A first network node, comprising:
at least one memory; and
at least one processor coupled with the at least one memory and configured to cause the first network node to:
receive a requirement for performance analytics of an application session comprising an end-to-end communication session that includes a tethered connection;
identify at least one device to serve as a data collection entity for collecting data for the performance analytics;
send a data collection requirement to the data collection entity, the data collection requirement including a request for performance data related to the tethered connection within the application session;
receive, from the data collection entity, the performance data measured in accordance with the data collection requirement;
derive the performance analytics based on the performance data and the data collection requirement; and
send the derived performance analytics.

2. The first network node of claim 1, wherein to receive the requirement for performance analytics comprises the at least one processor configured to cause the first network node to receive a subscription request from an analytics consumer.

3. The first network node of claim 1, wherein the requirement for performance analytics comprises at least one of:
an analytics event identity;
at least one target vertical application layer (VAL) user equipment (UE) identity;
a group identifier consisting of one or more tethering device identities and one or more tethered device identities;
information on one or more of a capability or access technology for the tethered connection;
positioning information associated with a target VAL UE identity;
a VAL session identity associated with the target VAL UE identity;
a VAL service identity associated with the target VAL UE identity;
a period of time for which measurements are collected;
a definition of an area for which the measurements are collected;
a confidence level of any derived performance analytics; or
an exposure level for providing analytics related to the tethered connection.

4. The first network node of claim 1, wherein the at least one processor is further configured to cause the first network node to select at least one data source for collection of data by the data collection entity.

5. The first network node of claim 1, wherein the performance data comprises one or more of historical data or real-time data.

6. The first network node of claim 1, wherein the data collection requirement comprises a subscription to at least one data source.

7. The first network node of claim 1, wherein the application session comprises at least one of an extended reality session, a mobile metaverse session, or an artificial intelligence application session.

8. The first network node of claim 1, wherein the performance analytics comprise at least one of:
statistics or predictions for a communication delay of the tethered connection;
the statistics or the predictions for an end-to-end delay considering the tethered connection as well as other segments in the end-to-end communication session; or
a determination as to whether a quality of service for the tethered connection is sustainable for a given session or time period.

9. The first network node of claim 1, wherein the performance analytics are sent to an application server or to a network unit.

10. A method performed by a first network node, the method comprising:
receiving a requirement for performance analytics of an application session comprising an end-to-end communication session that includes a tethered connection;
identifying at least one device to serve as a data collection entity for collecting data for the performance analytics;
sending a data collection requirement to the data collection entity, the data collection requirement including a request for performance data related to the tethered connection within the application session;
receiving, from the data collection entity, the performance data measured in accordance with the data collection requirement;
deriving the performance analytics based on the performance data and the data collection requirement; and
sending the derived performance analytics.

11. A second network node, comprising:
at least one memory; and
at least one processor coupled with the at least one memory and configured to cause the second network node to:
receive a data collection requirement from a first network node, the data collection requirement for performance analytics of an application session comprising an end-to-end communication session that includes a tethered connection;
determine at least one data source based on the data collection requirement;
collect performance data from the at least one data source based on the data collection requirement; and
send the collected performance data to the first network node.

12. The second network node of claim 11, wherein the at least one processor is further configured to cause the second network node to process the collected performance data before sending it to the first network node.

13. The second network node of claim 11, wherein the at least one processor is further configured to cause the second network node to:
determine if the collected performance data is sufficient to satisfy the data collection requirement; and
if the collected performance data is not sufficient to satisfy the data collection requirement, then request supplementary data.

14. The second network node of claim 11, wherein the performance data comprises an indication of a communication delay in the tethered connection.

15. The second network node of claim 11, wherein to collect the performance data comprises the at least one processor configured to cause the second network node to at least one of:
request end-to-end delay past measurements from an application client;
estimate a maximum latency and a minimum latency given non-line of sight and line of sight and using a relative location of end points of the tethered connection;
capture when a delay for the tethered connection exceeds a packet delay budget; or
perform local analytics based on a location of a tethered device, a communication technology used for the tethered connection, and a local environment and a time of day.

16. A method performed by a second network node, the method comprising:
receiving a data collection requirement from a first network node, the data collection requirement for performance analytics of an application session comprising an end-to-end communication session that includes a tethered connection;
determining at least one data source based on the data collection requirement;
collecting performance data from the at least one data source based on the data collection requirement; and
sending the collected performance data to the first network node.

17.-18. (canceled)

19. The method of claim 10, wherein the receiving the requirement for performance analytics comprises receiving a subscription request from an analytics consumer.

20. The method of claim 10, further comprising:
selecting at least one data source for collection of data by the data collection entity.

21. The method of claim 10, wherein the data collection requirement comprises a subscription to at least one data source.

22. The method of claim 10, wherein the performance analytics comprise at least one of:
statistics or predictions for a communication delay of the tethered connection;
the statistics or the predictions for an end-to-end delay considering the tethered connection as well as other segments in the end-to-end communication session; or
a determination as to whether a quality of service for the tethered connection is sustainable for a given session or time period.
